(19) United States
(12) Patent Application Publication
(10) Pub. No.: US 2005/0125332 A1
(43) Pub. Date: Jun. 9, 2005

(54) Electronic device operable as a trader in a market

(75) Inventor: David Trevor Cliff, Southville (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/953,363

(22) Filed: Sep. 30, 2004

(30) Foreign Application Priority Data
Oct. 3, 2003 (GB) 0323243.6

(51) Int. Cl. G06F 17/60

(52) U.S. Cl. 705/37

(57) ABSTRACT

An electronic device, operable as a trader in a market, the electronic device comprising: communication means for communicating a quote price to the market and for receiving a preceding market quote price made in the market; a plurality of trader agents including trader agents for buying by communicating a bid at a quote price in the market and trader agents for selling by communicating an offer at a quote price in the market; and selection means for selecting, in dependence upon the preceding market quote price and upon whether the device's next quote price is an offer or a bid, which of the plurality of trader agents communicates the next quote price to the market.

### FIELD OF THE INVENTION

Embodiments of the invention relate to electronic devices that trade in a market. Embodiments additionally relate to computer programs that enable trader agents, to methods of trading, and to methods of producing trader agents.

### BACKGROUND TO THE INVENTION

In a continuous double auction market, for a given resource, sellers quote offer prices and buyers simultaneously quote bid prices. The resource may be a physical entity or a service. A transaction occurs when a quote price of one party is accepted by another party.

The inventor developed Zero Intelligence Plus (ZIP) trader agents in 1996. It has since been suggested that such trader agents may be possible replacements for human traders. A computer program loaded into a computer and a set of eight parameter values typically specifies the operation of a market populated by ZIP trader agents.

A ZIP trader agent adapts its trading margins on the basis of its experience of the market. The operation of a standard ZIP trader is documented in, for example, UK Patent Application No GB2382679 and “Evolutionary Optimization of Parameter Sets for Adaptive Software-Agent Traders in Continuous Double-Auction Markets”, Technical Report HPL-2001-99, Hewlett-Packard Laboratories.

### BRIEF DESCRIPTION OF THE INVENTION

The term ‘trader agent’ is used in this document to include within its scope a man made entity that trades. Typically a trader agent is provided by software hosted by an electronic device, for example, a trader agent may be provided by software running on a general purpose computer.

According to one embodiment there is provided an electronic device, operable as a trader in a market, the electronic device comprising: communication means for communicating a quote price to the market and for receiving a preceding market quote price made in the market; a plurality of trader agents including trader agents for buying by communicating an offer at a quote price in the market and trader agents for selling by communicating a bid at a quote price in the market; and selection means for selecting, in dependence upon the preceding market quote price and upon whether the device's next quote price is an offer or a bid, which of the plurality of trader agents communicates the next quote price to the market.

According to another embodiment there is provided a method of trading in a market comprising: receiving a market quote price made in the market; selecting, in dependence upon the market quote price and upon whether the device's next quote price should be an offer or a bid, which of a plurality of trader agents makes a quote price to the market.

According to another embodiment there is provided an electronic device, for buying and selling in a market, the electronic device comprising: communication means for receiving a preceding market quote price made in the market and for communicating a next quote price to the market; a memory for storing a first parameter set and a second parameter set; means for initialising a first trading agent by selecting a first multiplicity of parameter values from a first multiplicity of parameter ranges specified by the first parameter set; means for initialising a second trading agent by selecting a second multiplicity of parameter values from a second multiplicity of parameter ranges specified by the second parameter set; means operable as the first trading agent that are arranged to use the first multiplicity of parameter values to adjust a quote price up or down in dependence on the received preceding market quote price; and means operable as the second trading agent that are arranged to use the second multiplicity of parameter values to adjust a quote price up or down in dependence on the received preceding market quote price; and selection means for selecting which of the first and second traders communicates a next quote price to the market.

According to another embodiment there is provided a method of specifying a trader agent comprising: defining a plurality of different specific events and grouping the specific events into general events; defining an ordered set of parameters, the set having a plurality of sub-sets associated with respective different specific events and groups of sub-sets associated with different respective general events; and optimising the ordered set of parameters wherein each sub-set is associated with an event and comprises ordered parameters specifying a trader agent operable subsequent to the associated event.

According to another embodiment there is provided a method of producing a set of parameters specifying a trader agent comprising: a) creating a population of genotypes, wherein each genotype comprises identifier gene, a first plurality of genes in sequence and one or more repetitions of the first plurality of genes in sequence, wherein each of the first plurality of genes represents a parameter value for specifying a trader agent; b) determining a fitness value for each genotype in the population; c) generating a new population of genotypes via cross-over on parent genotypes identified using fitness-based selection; d) mutating the new population of genotypes; e) processing each genotype of the new population in dependence upon its identifier gene; f) repeating steps b), c), d) e); and g) obtaining a set of parameters for specifying a trader agent from a selected genotype in the resultant population of genotypes.

According to another embodiment there is provided an electronic device, operable as a buyer in a market, the electronic device comprising: a memory for storing a parameter set that comprises first parameters for defining a first, constant, device-dependent range and second parameters for defining a second, constant, device-dependent range; a processor operable to adjust a bid quote price up or down towards a stochastic function of a preceding market quote price made in the market and to transact with a seller in the market, if any, whose offer quote price is less than the adjusted bid quote price, wherein the stochastic function comprises an absolute perturbation that is selected from the first constant device dependent range and a relative perturbation of the market quote price that is selected from the second constant device dependent range.

According to another embodiment there is provided a method of selling in a market comprising: selecting an absolute perturbation from a first constant device dependent range; selecting a relative perturbation from a second constant device dependent range; calculating a stochastic function value using the relative perturbation, a preceding market quote price and the absolute perturbation; adjusting a bid quote price up or down towards the stochastic function value; and transacting with a seller in the market, if any, whose offer quote price is less than the adjusted bid quote price

According to another embodiment there is provided a computer program comprising computer program instructions, which when loaded into a computer provide means for: selecting an absolute perturbation from a first constant device dependent range; selecting a relative perturbation from a second constant device dependent range; calculating a stochastic function value using the relative perturbation, a preceding market quote price and the absolute perturbation; adjusting a bid quote price up or down towards the stochastic function value; and transacting with a seller in the market, if any, whose offer quote price is less than the adjusted bid quote price

### BRIEF DESCRIPTION OF THE DRAWINGS

For a better understanding of the present invention and to understand how the same may be brought into effect reference will now be made, by way of example only, to the accompanying drawings, in which:

FIG. 1 illustrates a market place suitable for implementing an embodiment of the present invention; and

FIGS. 2A, 2B and 2C each illustrate the trading process for different trader agent.

### DETAILED DESCRIPTION OF EMBODIMENTS OF THE INVENTION

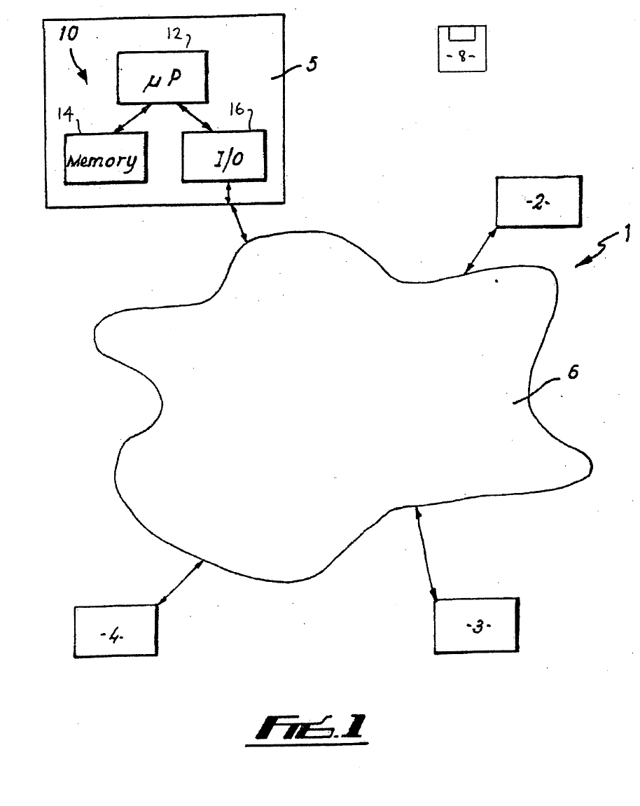

FIG. 1 shows a market 1 having four trading agents 2-5 that are arranged to trade. It should be noted, however, that the market 1 might have any number of traders including trader agents and human traders. In this embodiment each trading agent 2-5 is a software agent running on a conventional computer and they communicate via a network 6, in this case the Internet. However, any suitable host may be used as a trader agent and any suitable means for communicating may be used, which may involve a third party (not shown) for regulating the trading. In this example the trader agent 5 is hosted by a computer 10 comprising a memory 14, a processor 12 for performing instructions in accordance with a computer program that is stored in a memory 14 and a network adaptor 16 for communicating with the market 1. The Figure also illustrates a record carrier 8, which may be for example a floppy disc or CD-ROM, that embodies a computer program which when loaded into a computer provides a trading agent.

In the following description and claims reference is made to ‘communication means’. The communication means may be the network adaptor 16 or any suitable mechanism that facilitates communication such as, for example, a radio frequency transceiver or other input/output interface.

In the following description and claims reference is made to ‘selection means’, ‘means for initialising a trader agent’ and ‘means operable as a trader agent’. In the embodiment described in FIG. 1, the processor 12 operates under computer program instructions, to provide these means in the trader agent 5. In other alternative implementations, these means may be provided by a combination of electrical circuits or components.

The trader agents 2-5 in the market 1 adjust their profit margins up or down, on the basis of the prices of bids and offers made by the other traders in the market, and whether those quotes are accepted, leading to transactions, or ignored.

Each trader agent i maintains a profit margin μᵢ(t), which determines the quote-price, pᵢ(t). Increasing μᵢ(t) raises pᵢ(t) for a seller and lowers pᵢ(t) for a buyer. A trader agent will buy from any trader that makes an offer less than the buying agent's current bid quote price. Similarly, a trader agent sells to any trader making a bid greater than the selling agent's current offer quote price.

Each trader agent alters its profit margin on the basis of four factors, whether the trader is active in the market (i.e., still capable of making a transaction), or inactive (i.e., has sold or bought its full entitlement of units, and has ‘dropped out’ of the market for the remainder of this trading period). The three other factors all concern the last (most recent) market quote: its price, denoted by q(t); whether it was a bid or an offer; and whether it was accepted or rejected (i.e., whether it resulted in a transaction or not).

The operation of a trader agent is controlled in accordance with the following rules (events):

For a SELLING trader agent:

S1. if (the last quote was accepted at price q) then
any seller sᵢ for which pᵢ≦q should raise its profit margin—i.e. the seller sᵢ was trying to sell at too low a price and increasing the profit margin operates to increase the offer price.
S2. if (the last quote was accepted at price q) and (the last quote was a bid) then any active seller s, for which pᵢ≧q should lower its margin—i.e. the seller is being undercut by another seller and so needs to lower its profit margin, which will lower the offer price.
S3. if (the last quote was NOT accepted at price q) and (the last quote was an offer) then
any active seller s, for which pᵢ≧q should lower its margin—i.e. another selling trader is unsuccessfully trying to sell at a lower price and so this seller needs to lower its price and it reduces its profit margin.
   For a BUYING trader agent:
B1. if (the last quote was accepted at price q) then
   any buyer bᵢ, for which pᵢ≧q should raise its profit margin—i.e. the trader is offering to buy at too high a price, and increasing the profit margin lowers the trader's bid price.
B2. if (the last quote was accepted at price q) and (the last quote was an offer) then
   any active buyer bᵢ, for which pᵢ≦q should lower its margin—i.e. the trader is seeking to make too large a profit by buying too cheep and needs to lower its profit margin.
B3. if (the last quote was NOT accepted at price q) and (the last quote was a bid) then
   any active buyer bᵢ for which pᵢ≦q should lower its margin—i.e. another buying trader is seeking unsuccessfully to buy at a higher bid price so the buyer needs to increase its bid price.

Each trading agent i is given a private (secret) limit-price λᵢⱼ for each unit j. When the trading agent is acting as a seller the limit price is the price below which the trader must not sell. When the trading agent is acting as a buyer, the limit price is the price above which the trader must not buy. At a given time t, an individual trader agent i calculates the quote price pᵢ (t) for a unit j with a limit price λᵢⱼ using the trader's real-valued profit-margin μᵢ(t) according to the following equation:
pᵢ(t)=λᵢⱼ(1+μᵢ(t)) (1)
or expressed in another way:
μᵢ=p/λᵢⱼ−1
so that as the profit margin μₗ tends towards zero the quote price p tends towards the limit λ, and p/λ tends towards 1.

A seller's margin is raised by increasing μᵢ, and lowered by decreasing μᵢ, where μᵢ is a positive real value. The situation is reversed for buyers: they raise their margin by decreasing μᵢ, where μᵢ is a negative number between −1 and 0.

The value of μᵢ(t) for each trader is altered dynamically, in response to the actions of other traders in the market, increasing or decreasing to maintain a competitive match between that trader's quote-price and the quotes of the other traders. Each trading agent is given an initial value μ(0) (i.e., μ(t) for t=0) which is subsequently adapted over time using a machine learning technique, for example the Widrow-Hoff rule.
μᵢ(t+1)=[pᵢ(t)+┌₁(t)]/λᵢⱼ−1 (2)
which can be compared with equation (1):
where
┌ᵢ(t+1)=γᵢ┌ᵢ(t)+(1−γᵢ)Δᵢ(t) (3)
γᵢ is a momentum coefficient. If γᵢ=0 the trader takes no account of past changes when determining the next change to the value of the profit margin μᵢ, but with larger non-zero values of γᵢ greater emphasis is accorded to past changes.

Δᵢ(t) is the Widrow-Hoff delta value, calculated using the individual trader's learning rate βᵢ, the current quote price pᵢ(t) and the target price τᵢ(t).
Δᵢ(t)=βᵢ(τᵢ(t)−pᵢ(t)) (4)
There are many ways in which the target price τᵢ(t) could be determined, the following uses a stochastic function of the quote price q(t):
τᵢ(t)=Rᵢ(t)q(t)+Aᵢ(t) (5)

Where Rᵢ is a randomly generated coefficient that sets the target price relative to the price q(t) of the last quote, and Aᵢ(t) is a (small) random absolute price alteration (or perturbation). When the intention is to increase the dealer's quote price, Rᵢ>1.0 and Aᵢ>0.0; when the intention is to decrease it, 0.0<Rᵢ<1.0 and Aᵢ<0.0. Every time a trader's profit margin is altered, the target price is calculated using newly generated random values of Rᵢ and Aᵢ.

The Widrow-Hoff rule gives asymptotic convergence of p(t) to τ(t), at a speed determined by β. When a trader is required to increase or decrease its profit margin a ‘target price’ (denoted by τᵢ(t)) will be calculated for each trader, and the Widrow-Hoff rule will then be applied to take the trader's quote price on the next step (pᵢ(t+1)) closer to the target price τᵢ(t) .

ZIP 8 Traders

A ZIP8 trader agent is the standard, known ZIP trader agent. The operation of a ZIP8 trader agent is documented in, for example, GB2382679 and “Evolutionary Optimization of Parameter Sets for Adaptive Software-Agent Traders in Continuous Double-Auction Markets”, Technical Report HPL-2001-99, Hewlett-Packard Laboratories.

For this type of known trader, the random values of Rᵢ and Aᵢ, are independent and identically distributed for all traders. Aᵢ is a small random absolute perturbation generated from the uniform distribution U[O,ca} and Rᵢ is a small random relative perturbation generated from U[1−Cr, 1+Cr], where Ca and Cr are system constants. The generation occurs with each update of p(t), and where U[x,y] denotes a real value generated at random from a uniform distribution over the range [x,y].

The initial profit margin value μ(0), the constant momentum parameter value γ and the constant learning rate parameter value β are separately and randomly assigned to each ZIP8 trader from the same uniform distributions U, each of which is defined via “min” and “delta” parameters in the following fashion:
μ(O)=U(μmin, μmin+Δμ);
β=U(βmin, βmin+Δβ);
γ=U(γmin, γmin+Δγ).

The random assignment of parameter values from the same uniform distribution (in relation to ZIP 8 and related trader agents) will result in different trader agents having differing levels performance (although due to differing market circumstances it may not be possible to establish analytically in advance whether one agent is better than another). One environment in which such a population of trader agents finds utility is, for example, in an “internal” market, such as a market to allocate resources within a single commercial organisation. In such a market, because Ca and Cr are system constants the overall dynamic of the market thus populated is suitably controlled in accordance with the requirements of the organisation on whose behalf it is operating, so that the varying performance of individual trading agents in such a market, although possibly relatively detrimental to their principals, is not detrimental to the organisation creating the market. In an alternative exemplary scenario, such agents may be used in external commercial trading on behalf of competing commercial parties. In such a situation, all parties that engage a trader agent on their behalf would desirably be aware that their agent may not perform as well as another party's agent; the incentive for engaging such an agent however being the assurance that even in such circumstances the use of such an agent will reduce the likelihood of them incurring heavy losses.

To initialize an entire automated ZIP8 trading agent market it is necessary to specify 8 parameters—six market initialization parameters, μmin, Δμ, βmin, Δβ, γmin, Δγ and two perturbation system constants Ca and Cr. The trader agent is consequently termed a ZIP8 agent.

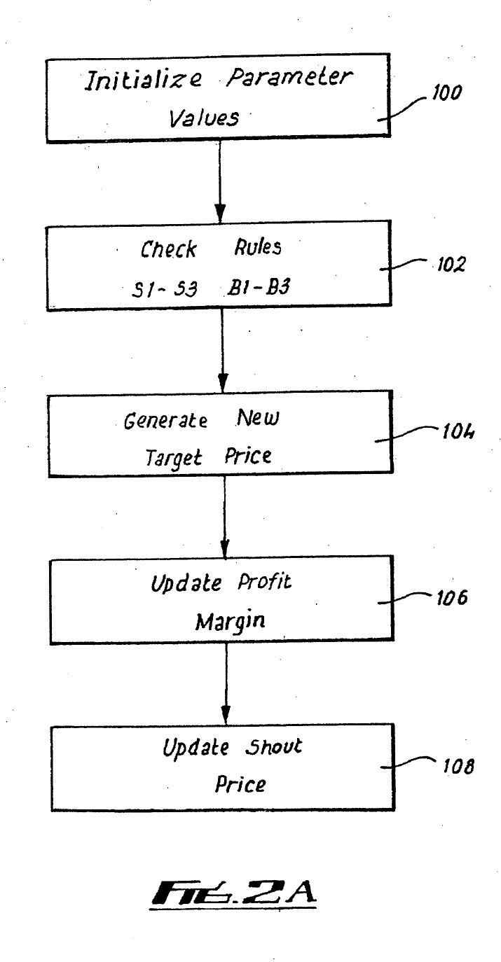

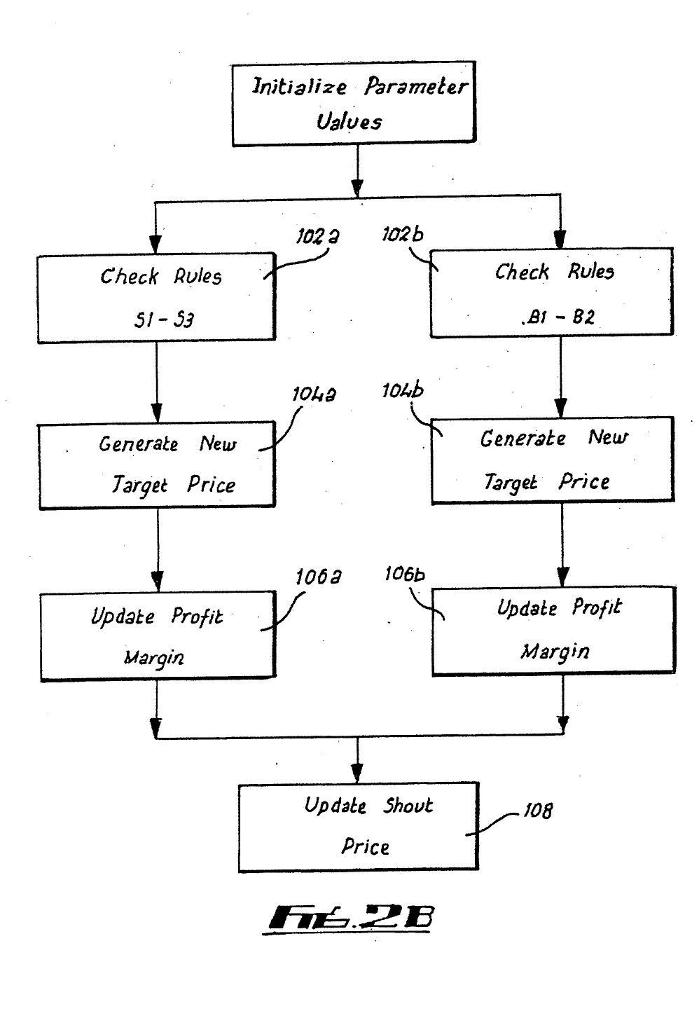

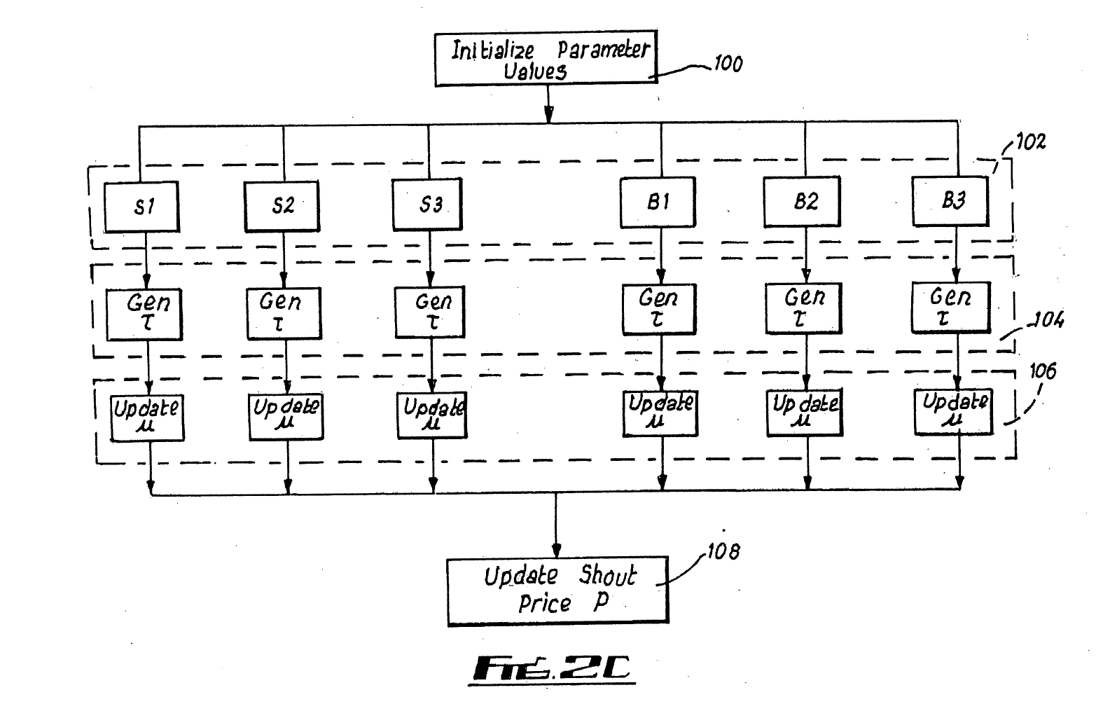

The trading process for a ZIP8 trader agent is illustrated in FIG. 2A. The parameters μmin, Δμ, βmin, Δβ, γmin, Δγ, Ca and Cr are predetermined, for example using an optimization algorithm.

At step 100 the three trader agent dependent parameter values μ(O), β and γ are initialized.
μ(O)=U(μmin, μmin+Δμ);
β=U(βmin, βmin+Δβ);
γ=U(γmin, γmin+Δγ).

Then at step 102 it is determined which, if any, of rules S1, S2, S3, B1, B2 and B3 are satisfied. If S2, S3, B2 or B3 is satisfied the profit margin μ(t) will be reduced. If S1 or B1 is satisfied the profit margin p(t) will be increased.

At step 104 Rᵢ(t) is randomly selected from U[1−Cr, 1+Cr], Aᵢ(t) is randomly selected from U[O, ca} and the new target price is calculated as τᵢ(t)=Rᵢ(t)q(t)+Aᵢ(t).

At step 106 Δᵢ(t) is calculated using the constant parameter value βᵢ, the newly calculated τᵢ(t) and using pᵢ(t). ┌ᵢ(t) is calculated using the constant parameter value γᵢ. ┌ᵢ(t−1) and Δᵢ(t). The profit margin is updated to μᵢ(t+1) using pᵢ(t), ┌ᵢ(t)) and the constant λᵢⱼ.

At step 108 the quote price pᵢ(t+1) is updated using the constant λᵢⱼ and the newly determined μᵢ(t+1)

ZIP 10 Trader Agent

For a Zip10 trader agent, the initial profit margin value μ(0), the constant momentum parameter value γ, the constant learning rate parameter value β, and Ca and Cr are separately and randomly assigned to each trader from the same uniform distributions U, each of which is defined via “min” and “delta” values in the following fashion:
μ(O)=U(μmin, μmin+Δμ);
β=U(βmin, βmin+Δβ);
γ=U(γmin, γmin+Δγ).
Ca=U(Ca_min, Ca_min+ΔCa);
Cr=U(Cr_min, Cr_min+ΔCr);

Hence, to initialize an entire automated trading agent market it is necessary to specify 10 market initialization parameters, γmin, Δμ, βmin, Δβ; γmin, Δγ, Ca_min, Δ Ca, Cr_min and ΔCr. The trader agent is consequently termed a ZIP10 agent.

For this type of trader agent, the random values of Rᵢ and Aᵢ, are independent and differently distributed for different traders. Aᵢ is a small random absolute perturbation generated from the uniform distribution U[O,ca} and Rᵢ is a small random relative perturbation generated from U[1−Cr, 1+Cr], where Ca and Cr are now randomly assigned parameter values.

The trading process for a ZIP10 trader agent is similar to that illustrated in FIG. 2A. The parameters βmin, Δμ, βmin, Δβ; γmin, Δγ, Ca_min, ΔCa, Cr_min and ΔCr are predetermined, for example using an optimization algorithm.

At step 100 the five trader agent dependent values μ(O), β, γ, Ca and Cr are initialized.
μ(O)=U(μmin, μmin+Δμ);
β=U(βmin, βmin+Δβ);
γ=U(γmin, γmin+Δγ).
Ca=U(Ca_min, Ca_min+ΔCa);
Cr=U(Cr_min, Cr_min+ΔCr);

Ca and Cr are no longer system constants, but trader agent dependent constants.

Then at step 102 it is determined which, if any, of rules S1, S2, S3, B1, B2 and B3 are satisfied.

At step 104 Rᵢ(t) is randomly selected from U[1−Cr, 1+Cr], Aᵢ(t) is randomly selected from U[O,ca} and the new target price is calculated as τᵢ(t)=Rᵢ(t)q(t)+Aᵢ(t).

The possible values for Ca are identically distributed across a common range for all trader agents, but the actual value of Ca used by a trader agent is randomly chosen from this range and is consequently trader agent dependent. Therefore the relative perturbation Rᵢ for each trader agent is randomly selected from a different trader agent dependent range.

The possible values for Cr are identically distributed across a common range for all trader agents, but the actual value of Cr used by a trader agent is randomly chosen from this range and is consequently trader agent dependent. Therefore the absolute perturbation Aᵢ for each trader is randomly selected from a different trader agent dependent range.

The target price is consequently a stochastic function of the quote price q(t), in which an absolute perturbation of the quote price q(t) is randomly selected from a constant trader agent dependent range and a relative perturbation of the quote price q(t) is randomly selected from a constant trader agent dependent range.

At step 106 Δᵢ(t) is calculated using the constant parameter value βᵢ, the newly calculated τᵢ(t) and using pᵢ(t). ┌ᵢ(t) is calculated using the constant parameter value γᵢ, ┌ᵢ(t−1) and Δᵢ(t). The profit margin is updated to μᵢ(t+1) using pᵢ(t), ┌ᵢ(t)) and the constant λᵢⱼ.

At step 108 the quote price pᵢ(t+1) is updated using the constant λᵢⱼ and the newly determined μᵢ(t+1)

ZIP 20 Trader Agent

For a ZIP20 agent, there are in effect two complimentary ZIP10 trader agents within a single ZIP20 trader agent. One that trades as a buyer and one that trades as a seller. Thus the operation of a ZIP20 trader as a buyer is independent of its operation as a seller.

The initial profit margin μ(0), the constant momentum parameter γ, the constant learning rate parameter β, and Ca and Cr are separately and randomly assigned to each ‘selling’ trader agent from the same uniform distributions U, each of which is defined via “min” and “delta” values.

The initial profit margin μ(0), the constant momentum parameter γ, the constant learning rate parameter β, and Ca and Cr are separately and randomly assigned to each ‘buying’ trader agent from the same uniform distributions U, each of which is defined via “min” and “delta” values.

There is therefore one set of initialization values {μ(O), B, γ, Ca, Cr}_{selling f}or use when a trader agent is selling,
μ(O)=U(μmin_{—}s, μmin_{—}s+Δμ_{—}s);
β=U(βmin_{—}s, βmin_{—}s+Δβ_{—}s);
γ=U(γmin_{—}s, γmin_{—}s+Δβ_{—}s).
Ca=U(Ca_min_{—}s, Ca_min_{—}s+ΔCa_{—}s);
Cr=U(Cr_min_{—}s, Cr_min_{—}s+ΔCr_{—}s);

There is another set of initialization values {μ(O), B, γ, Ca, Cr}_{buying} for use when the trader agent is buying
μ(O)=U(μmin_{—}b, μmin_{—}b+Δμ_{—}b);
β=U(βmin_{—}b, βmin_{—}b+Δβ_{—}b);
γ=U(γmin_{—}b, γmin_{—}b+Δγ_{—}b).
Ca=U(Ca_min_{—}b, Ca_min_{—}b+ΔCa_{—}b);
Cr=U(Cr_min_{—}b, Cr_min_{—}b+ΔCr_{—}b);

Hence, to initialize an entire automated trading agent market it is necessary to specify 20 market initialization parameters—10 for buying and 10 for selling. The trader agent is consequently termed a ZIP20 agent.

The trading process for a ZIP10 trader agent is illustrated in FIG. 2B. The 20 initialisation parameters are predetermined, for example using an optimization algorithm.

At step 100 the values μ(O), β, γ, Ca and Cr are initialized for buying and selling. If the trader agent is selling the process branches to step 102a and uses the initialization parameter values {μ(O), B, γ, Ca, Cr)_{selling}. If the trader agent is buying the process branches to step 102b and uses the initialization parameter values {μ(O), B, γ, Ca, Cr}_{buying}

At step 102a it is determined which, if any, of rules S1, S2, S3 are satisfied. At step 104a Rᵢ(t) is randomly selected from U[1−Cr, 1+Cr], Aᵢ(t) is randomly selected from U[O,ca} and the new target price is calculated as τᵢ(t)=Rᵢ(t)q(t)+Aᵢ(t). At step 106a Δᵢ(t) is calculated using the constant βᵢ, the newly calculated τᵢ(t) and using pᵢ(t). ┌ᵢ(t) is calculated using the constant γᵢ, ┌ᵢ(t−1) and Δᵢ(t). The profit margin is updated to μᵢ(t+1) using pᵢ(t), ┌ᵢ(t)) and the constant λᵢⱼ. The process then moves to step 108.

At step 102b it is determined which, if any, of rules B1, B2, B3 are satisfied. At step 104b Rᵢ(t) is randomly selected from U[1−Cr, 1+Cr], Δᵢ(t) is randomly selected from U[O,ca} and the new target price is calculated as τᵢ(t)=Rᵢ(t)q(t)+Δᵢ(t). At step 106b Δᵢ(t) is calculated using the constant βᵢ, the newly calculated τᵢ(t) and using pᵢ(t). ┌ᵢ(t) is calculated using the constant γᵢ, ┌ᵢ(t−1) and Δᵢ(t). The profit margin is updated to μᵢ(t+1) using pᵢ(t), ┌ᵢ(t)) and the constant λᵢⱼ. The process then moves to step 108.

At step 108 the quote price pᵢ(t+1) is updated using the constant λᵢⱼ and the newly determined μᵢ(t+1)

The two complimentary trader agents are represented by the two branches to FIG. 2B.

ZIP 40 Trader Agent

For a ZIP40 agent, there are in effect four complimentary ZIP10 trader agents within a single ZIP40 trader agent. One trades as a buyer when the margin μ is increasing (rule B1 satisfied). One trades as a buyer when the margin is decreasing (rules B2 or B3 satisfied). One trades as a seller when the margin μ is increasing (rule S1 satisfied). One trades as a seller when the margin μ is decreasing (rules S2 or S3 satisfied).

Referring to FIG. 1, the ZIP40 trader agent 5 is hosted by a computer 10. The processor 12 performs instructions in accordance with a computer program that is stored in the memory 14 and communicates in the market using the network adaptor 16. The processor 12 is consequently operable to provide any one of the four complimentary trader agents and provides means for determining which of the rules is satisfied and selection means for selecting the corresponding trader agent for use.

For a ZIP40 trader agent, the operation of a trader agent as a buyer is made independent of its operation as a seller. Furthermore a ZIP40 trader agent has an independent response for each of the four rule sets: S1; S2 & S3; B1; B2 & B3. Consequently, the ZIP40 trader agent comprises four independent but complimentary trader agents each of which is associated with different ones or combinations of the rules S1-S3 and B1-B3.

The initial profit margin value μ(0), the constant momentum parameter value γ, the constant learning rate parameter value β, and Ca and Cr are separately and randomly assigned to each complimentary trader agent from the same uniform distributions U, each of which is defined via “min” and “delta” values.

There is one set of initialization values {μ(O), B, γ, Ca, Cr}ₛ₁ for use when the trader agent is selling, and rule S1 is satisfied.
μ(O)=U(μmin_{—}s1, μmin_{—}s+Δμ_{—}s1);
β=U(βmin_{—}s1, βmin_{—}s1+Δβ_{—}s1);
γ=U(γmin_{—}s1, γmin_{—}s1+Δγ_{—}s1).
Ca=U(Ca_min_{—}s1, Ca_min_{—}s1+ΔCa_{—}s1);
Cr=U(Cr_min_{—}s1, Cr_min_{—}s1+ΔCr_{—}s1);

There is another set of initialization values {μ(O), B, γ, Ca, Cr}_{s2&S3} for use when a trader agent is selling, and rule S2 or S3 is satisfied.
μ(O)=U(μmin_{—}s23, μmin_{—}s23+Δμ_{—}s23);
β=U(βmin_{—}s23, βmin_{—}s23+Δβ_{—}s23);
γ=U(γmin_{—}s23, γmin_{—}s23+Δγ_{—}s23).
Ca=U(Ca_min_{—}s23, Ca_min_{—}s23+ΔCa_{—}s23);
Cr=U(Cr_min_{—}s23, Cr_min_{—}s23+ΔCr_{—}s23);

There is another set of initialization values {μ(O), B, γ, Ca, Cr}_{b1} for use when a trader agent is buying, and rule B1 is satisfied.
μ(O)=U(μmin_{—}b1, μmin_{—}b+Δμ_{—}b1);
β=U(βmin_{—}b1, βmin_{—}b1+Δβ_{—}b1);
γ=U(γmin_{—}b1, γmin_{—}b1+Δγ_{—}b1).
Ca=U(Ca_min_{—}b1, Ca_min_{—}b1+ΔCa_{—}b1);
Cr=U(Cr_min_{—}b1, Cr_min_{—}b1+ΔCr_{—}b1);

There is another set of initialization values {μ(O), B, γ, Ca, Cr}_{b2&b3} for use when a trader agent is buying, and rule B2 or B3 is satisfied.
μ(O)=U(μmin_{—}b23, μmin_{—}b23+Δμ_{—}b23);
β=U(βmin_{—}b23, βmin_{—}b23+Δμ_{—}b23);
γ=U(γmin_{—}b23, γmin_{—}b23+Δγ_{—}b23).
Ca=U(Ca_min_{—}b23, Ca_min_{—}b23+ΔCa_{—}b23);
Cr=U(Cr_min_{—}b23, Cr_min_{—}b23+ΔCr_{—}b23).

Hence, to initialize an entire automated trading agent market it is necessary to specify 40 market initialization parameters—10 for each rule group. The trader agent is consequently termed a ZIP40 agent.

The trading process for a ZIP40 trader agent is illustrated in FIG. 2C.

At step 100, the values μ(O), β, γ, Ca and Cr are initialized for each of the rule groups S1; S2 & S3; B1 and B2 & B3.

At step 102 it is determined which, if any, of rules S1, S2 or S3, B1, B2 or B3 are satisfied. If rule S1 is satisfied, the process branches to step 104 and uses the initialization values {μ(O), B, γ, Ca, Crγ_{S1}. If rule S2 is satisfied, the process branches to step 104 and uses the initialization values {μ(O), B, γ, Ca, Cr}_{S2&S3}. If rule S3 is satisfied, the process branches to step 104 and uses the initialization values {μ(O), B, γ, Ca, Cr)_{S2&S3}. If rule B1 is satisfied, the process branches to step 104 and uses the initialization values {μ(O), B, γ, Ca, Cr)_{B1}. If rule B2 is satisfied, the process branches to step 104 and uses the initialization values {μ(O), B, γ, Ca, Cr}_{B2&B3}. If rule B3 is satisfied, the process branches to step 104 and uses the initialization values {μ(O), B, γ, Ca, Cr}_{B2&B3}.

At steps 104 Rᵢ(t) is randomly selected from U[1−Cr, 1+Cr], Aᵢ(t) is randomly selected from U[O,ca} and the new target price is calculated as τ₁(t)=Rᵢ(t)q(t)+Aᵢ(t). At steps 106 Δᵢ(t) is calculated using the constant βᵢ, the newly calculated τᵢ(t) and using pᵢ(t). ┌ᵢ(t) is calculated using the constant γᵢ, ┌ᵢ(t−1) and Δᵢ(t). The profit margin is updated to μᵢ(t+1) using pᵢ(t), ┌ᵢ(t)) and the constant λᵢⱼ. The process then moves to step 108.

At step 108 the quote price pᵢ(t+1) is updated using the constant λᵢⱼ and the newly determined μᵢ(t+1)

ZIP 60 Trader Agent

For a ZIP60 trader agent, the operation of a trader agent as a buyer is made independent of its operation as a seller. Furthermore a ZIP60 trader agent has an independent response for each of the rules S1-S3 and B1-B3. Consequently, the ZIP60 trader agent comprises six independent but complimentary trader agents each of which is associated with one of the rules S1-S3 and B1-B3.

Referring to FIG. 1, the ZIP60 trader agent 5 is hosted by a computer 10. The processor 12 performs instructions in accordance with a computer program that is stored in the memory 14 and communicates in the market using the network adaptor 16. The processor 12 is consequently operable to provide any one of the six complimentary trader agents and provides means for determining which of the rules is satisfied and selection means for selecting which trader agent is used.

The initial profit margin value μ(0), the constant momentum parameter value γ, the constant learning rate parameter value β, and Ca and Cr are separately and randomly assigned to each complimentary trader agent from the same uniform distributions U, each of which is defined via “min” and “delta” values.

There is one set of initialization values {μ(O), B, γ, Ca, Cr}ₛ₁ for use when the trader agent is selling, and rule S1 is satisfied.
μ(O)=U(μmin_{—}s1, μmin_{—}s+Δμ_{—}s1);
β=U(βmin_{—}s1, βmin_{—}s1+Δβ_{—}s1);
γ=U(γmin_{—}s1, γmin_{—}s1+Δγ_{—}s1).
Ca=U(Ca_min_{—}s1, Ca_min_{—}s1+ΔCa_{—}s1);
Cr=U(Cr_min_{—}s1, Cr_min_{—}s1+ΔCr_{—}s1);

There is another set of initialization values {μ(O), B, γ, Ca, Cr}ₛ₂ for use when a trader agent is selling, and rule S2 is satisfied.
μ(O)=U(μmin_{—}s2, μmin_{—}s+Δμ_{—}s2);
β=U(βmin_{—}s2, βmin_{—}s2+Δβ_{—}s2);
γ=U(γmin_{—}s2, γmin_{—}s2+Δγ_{—}s2).
Ca=U(Ca_min_{—}s2, Ca_min_{—}s2+ΔCa_{—}s2);
Cr=U(Cr_min_{—}s2, Cr_min_{—}s2+ΔCr_{—}s2);

There is another set of initialization values {μ(O), B, γ, Ca, Cr}ₛ₃ for use when a trader agent is selling, and rule S2 is satisfied.
μ(O)=U(μmin_{—}s3, μmin_{—}s3+Δμ_{—}s3);
β=U(βmin_{—}s3, βmin_{—}s3+Δβ_{—}s3);
γ=U(γmin_{—}s3, γmin_{—}s3+Δγ_{—}s3).
Ca=U(Ca_min_{—}s3, Ca_min_{—}s3+ΔCa_{—}s3);
Cr=U(Cr_min_{—}s3, Cr_min_{—}s3+ΔCr_{—}s3);

There is another set of initialization values {μ(O), B, γ, Ca, Cr}_{b1} for use when a trader agent is buying, and rule B1 is satisfied.
μ(O)=U(μmin_{—}b1, μmin_{—}b1+Δμ_{—}b1);
β=U(βmin_{—}b1, βmin_{—}b1+Δβ_{—}b1);
γ=U(γmin_{—}b1, γmin_{—}b1+Δγ_{—}b1).
Ca=U(Ca_min_{—}b1, Ca_min_{—}b1+ΔCa_{—}b1);
Cr=U(Cr_min_{—}b1, Cr_min_{—}b1+ΔCr_{—}b1);

There is another set of initialization values {μ(O), B, γ, Ca, Cr}_{b2} for use when a trader agent is buying, and rule B2 is satisfied.
μ(O)=U(μmin_{—}b2, μmin_{—}b2+Δμ_{—}b2);
β=U(βmin_{—}b2, βmin_{—}b2+Δβ_{—}b2);
γ=U(γmin_{—}b2, γmin_{—}b2+Δγ_{—}b2).
Ca=U(Ca_min_{—}b2, Ca_min_{—}b2+ΔCa_{—}b2);
Cr=U(Cr_min_{—}b2, Cr_min_{—}b2+ΔCr_{—}b2).

There is another set of initialization values {μ(O), B, γ, Ca, Cr}_{b3} for use when the trader agent is buying, and rule B3 is satisfied:
μ(O)=U(μmin_{—}b3, μmin_{—}b3+Δμ_{—}b3);
β=U(βmin_{—}b3, βmin_{—}b3+Δβ_{—}b3);
γ=U(γmin_{—}b3, γmin_{—}b3+Δγ_{—}b3).
Ca=U(Ca_min_{—}b3, Ca_min_{—}b3+ΔCa_{—}b3);
Cr=U(Cr_min_{—}b3, Cr_min_{—}b3+ΔCr_{—}b3);

Hence, to initialize an entire automated trading agent market it is necessary to specify 60 market initialization parameters—10 for each rule. The trader agent is consequently termed a ZIP60 agent.

The trading process for a ZIP60 trader agent is illustrated in FIG. 2C.

At step 100, the values μ(O), B, γ, Ca and Cr are initialized for each of the rules S1, S2, S3, B1, B2 and B3.

At step 102 it is determined which, if any, of rules S1, S2, S3, B1, B2, B3 are satisfied.

If rule X is satisfied, the process branches to step 104ₛ₁ and uses the initialization values {μ(O), B, γ, Ca, Cr}ₓ, where X=S1, S2, S3, B1, B2 or B3.

At steps 104 Rᵢ(t) is randomly selected from U[1−Cr, 1+Cr], Aᵢ(t) is randomly selected from U[O,ca] and the new target price is calculated as τᵢ(t)=Rᵢ(t)q(t)+Aᵢ(t). At steps 106 Δᵢ(t) is calculated using the constant βᵢ the newly calculated τᵢ(t) and using pᵢ(t). ┌ᵢ(t) is calculated using the constant γᵢ, ┌ᵢ(t−1) and Δᵢ(t). The profit margin is updated to μᵢ(t+1) using pᵢ(t), ┌ᵢ(t)) and the constant λᵢⱼ. The process then moves to step 108.

At step 108 the quote price pᵢ(t+1) is updated using the constant λᵢⱼ and the newly determined μᵢ(t+1)

The six complimentary trader agents with a ZIP60 trader agent are represented by the six branches to FIG. 2C.

Evolutionary Optimization

Optimal trading agents may be created by a process of evolutionary optimization, which will now be described below.

For a ZIPn trader the n specified values can be regarded as n vectors spanning an n-dimensional vector space. Vectors in an n-dimensional space can be considered as genotypes having n genes.

“Evolutionary Optimization of Parameter Sets for Adaptive Software-Agent Traders in Continuous Double-Auction Markets”, Technical Report HPL-2001-99, Hewlett-Packard Laboratories, describes how it is possible to optimize the 8 parameter values of a ZIP8 trader, by allowing an initial population of 8-gene genotypes to evolve via a genetic algorithm into an optimized genotype that best satisfies an appropriate evaluation function.

Optimization using a genetic algorithm relies on the properties of inheritance and mutation to allow an optimal solution to be found after many generations. In each generation each individual within the population is evaluated and assigned a fitness value and the next generation's population is then generated via mutation and crossover on parents identified using rank-based selection.

The present optimization process introduces, for the purpose of creating, by means of evolutionary optimization, a new ‘virtual genotype’. The virtual genotype has 61 genes, each of which has a position p where p ranges from 0 to 60. The n gene actual genotype of each ZIPn trader is replicated z times such that n*z=60. Thus a ZIP10 trader is represented by a ‘virtual genotype’ in which the 10 gene actual genotype is replicated 6 times in succession. The ‘virtual genotype’ also has an additional initial gene, at position p=0, that identifies the n value of the trader.

Thus a ZIP 10 trader is represented by a ‘virtual genotype’ of size 61 genes. The first gene, at position p=0, is an identifier gene that identifies the virtual genotype as that of a ZIP10 trader agent. The next 10 genes (p=1, 2 . . . 10) specify the 10 parameter values of a ZIP10 trader agent. Each of the remaining five groups of 10 consecutive genes holds an exact copy of those 10 parameter values. The virtual genotype provides a capability for the ZIP 10 genotype to evolve into a ZIP20, ZIP40 and ultimately a ZIP60 genotype.

Thus a ZIP20 trader is represented by a ‘virtual genotype’ of size 61 genes. The first gene, at position p=0, is an identifier gene that identifies the virtual genotype as that of a ZIP20 trader agent. The next 10 genes (p=1, 2, 3 . . . 10) relate to the 10 parameter values of a buying ZIP20 trader agent. The next 20 consecutive genes (p=11, 12, 13 . . . 30) hold two consecutive exact copies of that 10-gene “buyer” sequence. The next 10 genes (p=31, 32, 33 . . . 40) then relate to the 10 parameter values of a selling ZIP20 trader agent, and the final group of 20 consecutive genes (p=41, 42, 43 . . . 60) holds two consecutive exact copies of those 10 “seller” parameter values.

Thus a ZIP 40 trader is represented by a ‘virtual genotype’ of size 61 genes. The first gene, at position p=0, is an identifier gene that identifies the virtual genotype as that of a ZIP40 trader agent. The next 10 genes (p=1, 2 . . . 10) relate to the 10 parameter values of a ZIP40 trader for rule S1. The next 10 genes (p=11, 12 . . . 20) relate to the 10 parameter values of a ZIP40 trader for rule S2. The next 10 genes (p=21, 22 . . . 30) relate to the 10 parameter values of a ZIP40 trader for rule S3 and will be the same as those for rule S2. The next 10 genes (p=31, 32 . . . 40) relate to the 10 parameter values of a ZIP60 trader for rule B1. The next 10 genes (p=41, 42 . . . 50) relate to the 10 parameter values of a ZIP60 trader for rule B2. The next 10 genes (p=51, 52 . . . 60) relate to the 10 parameter values of a ZIP60 trader for rule B3 and will be the same as those for rule B2.

Thus a ZIP 60 trader is represented by a ‘virtual genotype’ of size 61 genes. The first gene, at position p=0, is an identifier gene that identifies the virtual genotype as that of a ZIP60 trader agent. The next 10 genes (p=1, 2 . . . 10) relate to the 10 parameter values of a ZIP60 trader for rule S1. The next 10 genes (p=11, 12 . . . 20) relate to the 10 parameter values of a ZIP60 trader for rule S2. The next 10 genes (p=21, 22 . . . 30) relate to the 10 parameter values of a ZIP60 trader for rule S3. The next 10 genes (p=31, 32 . . . 40) relate to the 10 parameter values of a ZIP60 trader for rule B1. The next 10 genes (p=41, 42 . . . 50) relate to the 10 parameter values of a ZIP60 trader for rule B2. The next 10 genes (p=51, 52 . . . 60) relate to the 10 parameter values of a ZIP60 trader for rule B3.

An initial population of, for example, 30 ZIP10 individuals is randomly created, where each individual has a ‘virtual genotype’ consisting of the 61 genes as described above.

A new population of 30 individuals is created via ‘selective reproduction’ where a selection process ensures that fitter individuals are more likely to reproduce. The old population is then discarded. Each cycle of evaluating the current population and ‘breeding’ a new population from the fitter individuals is referred to as one ‘generation’. The genetic algorithm is ended after a certain large number of generations.

A simple rank-based tournament selection process may be used to select individuals for reproduction: three distinct individuals are randomly selected from the old (evaluated) population, and the fittest two of these are identified as the ‘parents’ of the new individual. The ‘fitness’ for each individual virtual genotype may for example be calculated by monitoring price convergence in a series of 50 continuous double auction (CDA) market experiments, all with predetermined supply and demand curves.

Let Vmom denote the fitter of the two parents and let Vdad denote the other parent. Also, let Vkid denote the new individual.

The ‘reproduction’ process copies the values of the dominant parent's gene into the genes of Vkid. Vmom is initially dominant and the process starts copying the genes of Vmom into the genes of Vkid. A uniform random value x=U [0.0,1.0] is generated before each copy. If x is less than some threshold Tx then the identity of the dominant parent is swapped e.g. the copying process ‘crosses-over’ so that the next gene of Vkid would be copied from Vdad instead of Vmom or visa versa; otherwise, copying continues from the current dominant parent. This is a so-called stochastic multi-point crossover process.

The value of each gene in Vkid is also ‘mutated’. The initial identifier gene may be mutated to identify one of a set of ZIPM agents e.g. a ZIP10 identifier could be mutated to a ZIP20 identifier or a ZIP60 identifier. Mutation for the remaining genes may, for example, add a random real value generated from U(−0.05, +0.05), and clip the result at 0.0 and 1.0 to ensure that Vᵢ∈[0,1].

If the identifier gene is not mutated and remains ZIP10, the next 10 genes, p=1, 2 . . . 10, following the identifier gene are mutated. Each of the remaining five groups of 10 consecutive genes is then adapted to hold an exact copy of those 10 mutated genes. Thus a ZIP 10 virtual genotype is equivalent to a ZIP 60 genotype that has identical sets of parameters for each of rules B1 to B3 and S1 to S3.

If the identifier gene is mutated to ZIP20, the first 10 genes (p=1, 2 . . . 10) following the identifier gene are mutated and are copied into the next 10 consecutive genes (p=11, 12, 13 . . . 20) and also into the following 10 consecutive genes (p=21, 22, 23 . . . 30). The 10 genes at positions 31 to 40 are then similarly mutated and copied into the next 10 consecutive genes (p=41, 42 . . . 50) and also into the following 10 consecutive genes (p=51, 52, 53 . . . 60). Thus a ZIP 20 virtual genotype is equivalent to a ZIP 60 genotype that has one identical set of parameters for each of the rules B1 to B3 and another, different set of parameters for each of the rules S1 to S3.

If the identifier gene is mutated to ZIP60, the next 60 genes following the identifier gene are mutated, representing different sets of parameters for each of the rules B1 to B3 and S1 to S3.

It will be understood that the use of a virtual genotype layout such as this makes the gene loci homologous and hence readily crossable between parents with different identifier genes.

The practice of elitism may also employed: on each generation, one unadulterated copy of the best individual in the old population is copied into the new population, thereby helping ensure that the best individual found so far is always retained.

At the end of many generations an optimized population is achieved and the fittest individual is chosen. This individual defines the type of ZIP agent (e.g. ZIP10, 20, 60) and its initial parameters. Although the process starts with all ZIP10 agents, by its conclusion the population is generally exclusively ZIP60 agents. The fittest genotype is then selected from the final population. The initial gene is inspected to determine the type of trader agent the genotype represents—ZIP10, ZIP20 or ZIP60. The initialisation parameters are then extracted from the genotype. If the genotype represents a ZIP10 trader agent the 10 genes following the initial identifier gene are extracted as the initialisation parameters. If the genotype represents a ZIP20 trader agent the 20 genes following the initial identifier gene are extracted as the initialisation parameters. If the genotype represents a ZIP60 trader agent the 60 genes following the initial identifier gene are extracted as the initialisation parameters.

The novel ZIP traders described above have a large number of industrial applications. They can for example be used to efficiently allocated scarce resources. For example, they may be used to allocate shared computer resources (e.g. processing, memory, bandwidth) amongst a plurality of users. Each user may be represented by a trader agent that seeks to buy particular resources. The common resources may be sold by trader agents. The price for each resource would quickly equilibrate at the market price. Another application for ZIP traders is as commodity, equity or currency traders in the financial markets.

Although embodiments of the present invention have been described in the preceding paragraphs with reference to various examples, it should be appreciated that modifications to the examples given can be made without departing from the spirit and scope of the invention.

1. An electronic device, operable as a trader in a market, the electronic device comprising:
communication means for communicating a quote price to the market and for receiving a preceding market quote price made in the market;
a plurality of trader agents including trader agents for buying by communicating an offer at a quote price in the market and trader agents for selling by communicating a bid at a quote price in the market; and
selection means for selecting, in dependence upon the preceding market quote price and upon whether the device's next quote price is an offer or a bid, which of the plurality of trader agents communicates the next quote price to the market.

2. An electronic device as claimed in claim 1, wherein any one of the trader agents is capable of calculating the next quote price from the current quote price and the selection of a trader agent is dependent upon a comparison between the current quote price and the preceding market quote price.

3. An electronic device as claimed in claim 1, wherein at least one of the trader agents is capable of calculating the next quote price from the current quote price by adjusting the current quote price up or down towards a value generated by a stochastic function.

4. An electronic device as claimed in claim 3, wherein the stochastic function comprises an absolute perturbation of the current quote price and a relative perturbation of the current quote price, wherein the absolute perturbation for a trader agent is randomly selected from a range specified for that trader agent that is independent of the ranges specified for the other trader agents of the device and the relative perturbation for a trader agent is randomly selected from a range specified for that trader agent that is independent of the ranges specified for the other trader agents of the device.

5. An electronic device as claimed in claim 4, further comprising a memory for storing a plurality of parameter sets wherein each parameter set comprises:
parameters that specify the range of possible absolute perturbations;
parameters that specify the range of possible relative perturbations;
parameters that specify a range of possible convergence speed values, where a convergence speed value determines the speed at which the current quote price converges towards the stochastic function;
parameters that specify a range of possible initial prices;
parameters that specify a range of possible momentum values, where a momentum value determines the extent that past adjustments in the quote price affect the next adjustment in the quote price.

6. An electronic device as claimed in claim 5, wherein on initialisation of a trader agent there is an initial selection of a constant convergence speed, an initial price, a constant momentum value, an absolute perturbation value and a relative perturbation value

7. An electronic device as claimed in claim 1, wherein the selection means is operable:
(i) to select a first trader agent if the next quote is an offer and the preceding market quote was accepted at a price that is greater than the current quote price;
(ii) to select a second trader agent if the next quote is an offer and the preceding market quote was a bid accepted at a price less than the current quote price;
(iii) to select a third trader agent if the next quote is an offer and the preceding market quote was an unaccepted offer at a price less than the current quote price;
(iv) to select a fourth trader agent if the next quote is a bid and the preceding market quote was accepted at a price that is less than the current quote price;
(v) to select a fifth trader agent if the next quote is a bid and the preceding market quote was an offer accepted at a price greater than the current quote price; and
(vi) to select a sixth trader agent if the next quote is a bid and the preceding market quote was an unaccepted bid at a price greater than the device's current quote price.

8. An electronic device as claimed in claim 1, comprised of a programmed computer.

9. A computer program comprising computer program instructions which when loaded into a computer enables an electronic device as claimed in claim 1.

10. A computer program for trading in a market, comprising computer program instructions which when loaded into a computer provide:
a plurality of complimentary trader agents wherein each trader agent is operative for a different combination of a preceding market quote price range and whether the next trade will be to buy or sell; and
selection means for selecting which of the plurality of complimentary trader agents is operative to calculate the next quote price.

11. A method of trading in a market comprising:
receiving a market quote price made in the market;
selecting, in dependence upon the market quote price and upon whether the device's next quote price should be an offer or a bid, which of a plurality of trader agents makes a quote price to the market.

12. A computer program comprising computer program instructions which when loaded into a computer enable the method of claim 11.

13. An electronic device, for buying and selling in a market, the electronic device comprising:
communication means for receiving a preceding market quote price made in the market and for communicating a next quote price to the market;
a memory for storing a first parameter set and a second parameter set; means for initialising a first trading agent by selecting a first multiplicity of parameter values from a first multiplicity of parameter ranges specified by the first parameter set;
means for initialising a second trading agent by selecting a second multiplicity of parameter values from a second multiplicity of parameter ranges specified by the second parameter set;
means operable as the first trading agent that are arranged to use the first multiplicity of parameter values to adjust a quote price up or down in dependence on the received preceding market quote price; and
means operable as the second trading agent that are arranged to use the second multiplicity of parameter values to adjust a quote price up or down in dependence on the received preceding market quote price; and
selection means for selecting which of the first and second traders communicates a next quote price to the market.

14. An electronic device as claimed in claim 13, wherein the first trader agent is for buying and the second trader agent is for selling.

15. An electronic device as claimed in claim 14, wherein any one of the trader agents is capable of calculating the next quote price from the current quote price and the selection of a trader agent is dependent upon a comparison between the current quote price and the preceding market quote price.

16. A computer program comprising computer program instructions which when loaded into a computer enable an electronic device as claimed in claim 13.

17. A method of specifying a trader agent comprising:
defining a plurality of different specific events and grouping the specific events into general events;
defining an ordered set of parameters, the set having a plurality of sub-sets associated with respective different specific events and groups of sub-sets associated with different respective general events; and
optimising the ordered set of parameters wherein each sub-set is associated with an event and comprises ordered parameters specifying a trader agent operable subsequent to the associated event.

18. A method as claimed in claim 17, wherein optimising the ordered set of parameters comprises:
random generation of ordered sets of parameters;
testing the generated ordered sets of parameters; and
selecting tested generated ordered sets of parameters.

19. A method as claimed in claim 17, wherein the sub-sets are equally sized.

20. A method as claimed in claim 19, wherein the sub-sets contain ten parameters.

21. A method as claimed in claim 17, wherein the set of parameters has the same ordered parameters in multiple sub-sets.

22. A method as claimed in claim 17, wherein, during optimization, there is generated an ordered set of parameters in which each sub-set is associated with one general event and each sub-set comprises the same ordered parameters specifying the same trader agent operable subsequent to the associated general event.

23. A method as claimed in claim 17, wherein, during optimization, there is generated an ordered set of parameters in which a first plurality of sub-sets is associated with a first general event and a second plurality of sub-sets is associated with a second general event and each of the first plurality of sub-sets separately comprise first ordered parameters specifying the same first trader agent operable subsequent to the associated first general event and each of the second plurality of sub-sets separately comprise second ordered parameters specifying the same second trader agent operable subsequent to the associated second general event.

24. A method as claimed in claim 17, wherein, during optimization, there is generated an ordered set of parameters in which a first plurality of sub-sets is associated with a general event and a second sub-set is associated with a specific event and each of the first plurality of sub-sets comprises first ordered parameters specifying the same first trader agent operable subsequent to the associated general event and the second sub-set comprises second ordered parameters specifying the same second trader agent operable subsequent to the associated specific event.

25. A method as claimed in claim 17, wherein, during optimization, there is generated an ordered set of parameters in which each of the sub-sets is associated with a specific event and each sub-set comprises different ordered parameters specifying a different trader agent operable subsequent to the associated specific event

26. A method as claimed in claim 17, wherein a sub-set of parameters at least comprises:
parameters that specify a range of possible absolute perturbations of a stochastic function;
parameters that specify the range of possible relative perturbations of the stochastic function;
parameters that specify a range of possible convergence speed values, wherein a convergence speed value determines the speed at which a quote price converges towards the stochastic function;
parameters that specify a range of possible initial quote prices; and
parameters that specify a range of possible momentum values, wherein a momentum value determines the extent that past adjustments in the quote price affect the next adjustment in quote price.

27. A trader agent specified in accordance with claim 1.

28. A computer program comprising program instructions which when loaded in a computer enable the method of claim 1.

29. A method of producing a set of parameters specifying a trader agent comprising:
a) creating a population of genotypes, wherein each genotype comprises identifier gene, a first plurality of genes in sequence and one or more repetitions of the first plurality of genes in sequence, wherein each of the first plurality of genes represents a parameter value for specifying a trader agent;
b) determining a fitness value for each genotype in the population;
c) generating a new population of genotypes via cross-over on parent genotypes identified using fitness-based selection;
d) mutating the new population of genotypes;
e) processing each genotype of the new population in dependence upon its identifier gene;
f) repeating steps b), c), d) e); and
g) obtaining a set of parameters for specifying a trader agent from a selected genotype in the resultant population of genotypes.

30. A method as claimed in claim 29, wherein the fitness of each genotype is determined by monitoring price convergence in a series of market experiments, having predetermined supply and demand curves.

31. A method as claimed in claim 29, wherein the new population is generated using a stochastic multi-point crossover process.

32. A method as claimed in claim 29, wherein the identifier gene is at a fixed predetermined position of a genotype.

33. A method as claimed in claim 29, wherein the identifier gene identifies the number of genes in the first plurality of genes.

34. A method as claimed in claim 29, wherein the identifier gene of a genotype in a new population is inherited from the fittest parent genotype.

35. A method as claimed in claim 29 wherein the step of processing comprises, if the identifier gene is a first identifier gene, the creation of a new genotype in which the first identifier gene is inherited and a first plurality of genes is repeated multiple times and, if the identifier gene is a second identifier gene, the processing does not alter the genotype.

36. A method as claimed in claim 29, wherein, in step g), the identifier gene in the selected genotype specifies the type of trader agent and determines the number of parameters in the obtained set of parameters.

37. A method as claimed in claim 29, wherein each genotype has a fixed length.

38. A method as claimed in claim 29, wherein each of the initial population of genotypes created in step a) have repeated gene sequences of minimum length.

39. A trader agent specified by a set of parameters obtained in accordance with claim 29.

40. A trader agent as claimed in claim 29, wherein the set of parameters at least comprises:
parameters that specify a range of possible absolute perturbations of a stochastic function;
parameters that specify the range of possible relative perturbations of the stochastic function;
parameters that specify a range of possible convergence speed values, wherein a convergence speed value determines the speed at which a quote price converges towards the stochastic function;
parameters that specify a range of possible initial quote prices;
parameters that specify a range of possible momentum values, wherein a momentum value determines the extent that past adjustments in the quote price affect the next adjustment in quote price.

41. A computer program comprising program instructions which when loaded in a computer enable the method of claim 29.

42. An electronic device, operable as a buyer in a market, the electronic device comprising:
a memory for storing a parameter set that comprises first parameters for defining a first, constant, device-dependent range and second parameters for defining a second, constant, device-dependent range;
a processor operable to adjust a bid quote price up or down towards a stochastic function of a preceding market quote price made in the market and to transact with a seller in the market, if any, whose offer quote price is less than the adjusted bid quote price, wherein the stochastic function comprises an absolute perturbation that is selected from the first constant device dependent range and a relative perturbation of the market quote price that is selected from the second constant device dependent range.

43. An electronic device as claimed in claim 42, additionally operable as a seller in a market, wherein the processor is additionally operable to adjust an offer quote price up or down toward a stochastic function of a preceding market quote price made in the market system and to transact with a buyer in the market system, if any, whose bid quote price is less than the offer quote price.

44. An electronic device as claimed in claim 42, wherein the parameter set additionally comprises:
parameters that specify a range of possible convergence speed values, wherein a convergence speed value determines the speed at which the quote price converges towards the stochastic function;
parameters that specify a range of possible initial prices; and
parameters that specify a range of possible momentum values, wherein a momentum value determines the extent that past adjustments in the quote price affect the next adjustment in quote price.

45. An electronic device as claimed in claim 42, wherein the processor, on initialisation, randomly selects a constant convergence speed, an initial price, a constant momentum value, an absolute perturbation value and a relative perturbation value.

46. An electronic device as claimed in claim 45, wherein the processor, after initialisation, randomly selects an absolute perturbation value and a relative perturbation value.

47. A method of selling in a market comprising:
selecting an absolute perturbation from a first constant device dependent range;
selecting a relative perturbation from a second constant device dependent range;
calculating a stochastic function value using the relative perturbation, a preceding market quote price and the absolute perturbation;
adjusting a bid quote price up or down towards the stochastic function value; and
transacting with a seller in the market, if any, whose offer quote price is less than the adjusted bid quote price

48. A computer program comprising computer program instructions, which when loaded into a computer provide means for:
selecting an absolute perturbation from a first constant device dependent range;
selecting a relative perturbation from a second constant device dependent range;
calculating a stochastic function value using the relative perturbation, a preceding market quote price and the absolute perturbation;
adjusting a bid quote price up or down towards the stochastic function value; and
transacting with a seller in the market, if any, whose offer quote price is less than the adjusted bid quote price

49. A record carrier embodying the computer program of claim 48.

50. A record carrier embodying the computer program of claim 10.
